(19) United States
(12) Patent Application Publication
(10) Pub. No.: US 2010/0057816 A1
(43) Pub. Date: Mar. 4, 2010

(54) Organizing Internet/Intranet research with interactive Dynamic Research Diagrams and Lists

(76) Inventor: Eric May, Boulder, CO (US)

Correspondence Address: Eric May, 560 Brook Rd, Boulder, CO, 80302, US

(21) Appl. No.: 12/547,389

(22) Filed: Aug. 25, 2009

Related U.S. Application Data
(60) Provisional application No. 61/136,297, filed on Aug. 26, 2008.

(51) Int. Cl. G06F 7/00

(52) U.S. Cl. 707/800; 707/E17.044

(57) ABSTRACT

This is a method of visually organizing research including: progress, history, decisions, notes and results. This method automatically records the details of a research project as it is happening and intuitively allows the user and/or users to add their own information in the process. Organization may be both automatically and manually conducted. The user's research may be displayed in multiple visual layouts allowing for quick review, organization and accessibility to other users.

This patent application claims priority under 35 U.S.C. 119(e) to provisional patent application Ser. No. 61/136,297

### FIELD OF INVENTION

The present invention relates generally to research tools and web browsers.

### BACKGROUND OF INVENTION

Currently users needing to perform research on the Internet are forced to use multiple programs and workarounds in order to conduct their research. Web browsers such as Internet Explorer, Firefox and Safari employ a means of recording bookmarks of visited websites, and users have the ability to copy and paste information from the Internet into a text editing program in order to save information. These currently available tools and workarounds are prone to lost information, missed opportunities and are difficult to share with others. As the Internet continues to grow in popularity as a research tool a more advanced and complete system of recording the details, progress, decisions and results of online research are required.

### SUMMARY OF INVENTION

Dynamic Research Diagrams and Dynamic Lists facilitate the research process by automatically and manually allowing users to organize the contents of a research project. By implementing various Internet technologies large amounts of information may be “hidden” from immediate view while still being immediately accessible. This allows for a simpler layout and viewing without compromising the quality and quantity of information available. This system incorporates both diagrams and list views, as both styles have advantages depending on the goal of the researcher.

A new research project may be created by a user by “starting” a new project. This may be accomplished by a button click or similar method. The user may then add additional information describing the project such as a “title” and “goal”. A user may also add key words(tags) to the research project to facilitate future reference. Once the researcher has created a project they can begin aggregating information into their project. This information may be saved indefinitely in the database. This information may come from a number of different sources including: content from webpages, statistical data, user created content and/or user uploaded content. Projects may assigned multiple levels of privacy to control viewing by other users.

Dynamic Research Diagrams and Dynamic Lists contain a similar set of features and tools. Providing a visual organization of information that is readily accessible. Temporarily removing information from view with various Internet technologies allows for a simplified overview of a research project while allowing for immediate access to the “hidden” information. The main differences between Dynamic Research Diagrams and Dynamic Lists is the types of information display they are best suited for. Dynamic Research Diagrams allow the user to quickly see decision points in the form of “branches” in the diagram. This intuitively allows other users to see how a conclusion was reached. Dynamic Lists allow the user to view saved information inline within the research project. This is particularly useful when the user has saved a number of short excerpts from various sites and needs to see all of them on the same page. For example this may be useful for viewing multiple forum posts simultaneously when necessary to get a complete “answer.”

A number of organizational elements are available to users some of which are automatic and some of which are user controlled. Information Boxes are the primary containers in which web page and/or idea specific information is stored. To further increase organization there are a number of types of Information Boxes available. These may include: Start, Information, Decision, Dead End, Note, Uploaded, Conclusion, Tangent, List Page, Subsearch and Related Search(which may referenced by the site name).

A Start box may reference the beginning of a new line of research. For example the results page from a search engine.

An Information Box is the default form of Information box and may reference a useful piece of information.

A Decision box may be automatically generated when multiple pieces of information are generated from the same point of origin or if a user returns to reference an earlier recorded Information Box and continues a line or research from that point.

A Dead End box is an example of a, user selectable, optional style of Information Box. A “dead end” box may be used to represent the end of particular line of inquiry or negative information. For example finding an article which clearly states “don't buy one”. Negative findings are commonly left out of research because it requires effort on the researchers part to “record” the negative finding. These omissions may lead wasted time and effort debating the credibility of the negative finding or having to track down the “dead end” again to satisfy curiosity. When involved in a collaborative research environment, the efficient recording of “dead ends” can greatly facilitate progress within a team.

A Note box may reference a Information Box linked to a user created content within a research project. This may include user generated and uploaded content with its primary connotation being user created content. A

Uploaded box may reference a Information Box linked to a user uploaded content within a research project. This may include user generated and uploaded content with its primary connotation being uploaded content.

Subsearches are another method of organizing research allowing a subset of information in a research project to be designated a Subsearch. All of the selected Information Boxes may then be condensed into a single Information Box within the main Dynamic Research Diagram and/or List. When a user goes to the Subsearch they will see the same layout and information the selected subset of Information Boxes had in the main search. This allows for the simplification of the main project while retaining the connections to the relevant information contained in the Subsearch. For example while planning a wedding there are a number of elements that need to be researched such as: locations, caterers, floral arrangements, guest accommodations, etc. While all of these elements fall under the project title “Wedding Plan” the variety of information can quickly become jumbled. With Subsearches each of these elements could be it's own Subsearch while still maintaining it's connections to the main project.

List Pages are another method of organizing research. A List Page can be generated by selecting any number of Information Boxes within a research project and creating a List Page from them. While Subsearches by default remove Information Boxes from the main project with List Pages this may be optional. This allows List Pages to be used for simplifying the main research project as well as for generating a list of information that may be used for a purpose divergent from the main project. They can also be used to generate a quick review of a subset of information from within the main project. For example, a list of ski tickets prices for all the resorts in Colorado. Since information within the project can be saved indefinitely and links to the original pages are also saved this provides a helpful reference for future research. A List Page may also be leveraged to provide an archive of saved information from a site that changes frequently. For example, the same web page from a visited site may be saved multiple times within a List Page, thus providing the user with the ability to archive changes. Users also have the ability to reorder Information Boxes in a List Page. This allows the user to order information in other formats besides the standard chronological format of Dynamic Research Diagrams and Dynamic Lists.

Conclusion Pages are another method of organizing research similar to List Pages. A Conclusion Page is by default the last Information Box on a page and can be generated by selecting any number of Information Boxes within a research project and creating a Conclusion Page from them. This process does not remove Information Boxes from the main project. Within the Conclusion Page a user may also add additional Note Pages. This can be very useful when writing reports since these Note pages may be selected and joined into a single document to form a Custom Report. Reports can be printed and/or exported from a research project in the form of PDFs.

A Related Research box may be used to reference related research projects and/or elements of preexisting research projects. In this way a separate research project may be included within the context of a new research project without becoming intermingled. For example a user may claim the benefits of a preexisting research projects findings and conclusions without claiming ownership of the preexisting research. Another use would be if a user wishes to dispute an preexisting research project and needs to quote from said project.

The main structure of a Dynamic Research Diagram may be chronological with each successive Information Box being added below the previous Information Box. There are several exceptions to this overall structure. In a Research Diagram view; when a user returns to a previously saved web page and continues their line of research from that page, the resulting Information Boxes may branch horizontally below the original Information Box. This may also convert the original Information Box into a “Decision” Information Box (The user can override this process for formatting reasons). This process facilitates identifying information crucial to the decision process. When Information Boxes are added out of chronological order the Information Box may also contain a graphic and/or text to signify that it has been “added.” For example when another user reviews the research project they may wish to add Information Boxes within the context of the original search.

By use of a Information Box menu a user can collapse/hide Information Boxes within a Research Diagram and/or list which can further simplify their view of a research project of be used to identify certain types of information. For example a user may collapse everything except the “Dead End” Information Boxes giving them a quick overview of why certain lines of inquiry have been terminated. By using the “user” menu in a similar fashion a user can see what contribution another user and/or users has made to the project.

Mnemonic devices may be employed within the context of a diagram and/or list to further assist accessibility, association and memory. These mnemonic devices may include, graphics, lines, icons, Favicons, color and content containers. Some have additional functionality such as Favicons which when activated may reveal information about the represented web page and/or site. Examples include: a thumbnail of a web page, full URL, time and date stamps, number of times a page has been viewed by user(s) and additional information about the site. Tangent icons have the function of being a quick link to the Tangent Search they reference. Users may also define their own collections of icons which can be used as their industry specific and/or personal mnemonic devices. Other site specific icons may indicate the type Information Box. These icons may also then be used to indicate the nature of a collapsed/hidden Information Box.

Content from and links to visited web pages may be stored for future reference. A check for updates feature automatically tracks changes to and availability of originally captured information. Users may also include notes at the time information is added to the project. This information may also be added and/or edited later. A user may also include notes and other information into their research project in the form of Note Pages. These are WYSIWYG editable pages which may include text and graphics. Users may also upload images, documents, videos and other types of information to the site for inclusion in their research projects. This information may be uploaded from within the research project and displayed within an “Upload” page. A user may also highlight the most recently added information within a research project. This is particularly helpful when multiple users are working on the same project and/or when Information Boxes are inserted into a project out of chronological sequence.

Statistical data about a visited web page may be stored automatically including: name of user visiting page, time and date stamp of visit and duration of time spent on page. Statistical information may be stored about the project including, number of pages visited, time spent on the project and number of individuals (cosearchers), working on the project.

Tangents allow for natural research development and accommodates the normal human tendency to quickly move from one line of inquiry to another unrelated line of inquiry. For example a user researching a computer purchase may realize they need to upgrade their software as well. Being able to designate this new line of research a tangent allows them to move from one line of research to another while still maintaining the central focus of their research project. Within the context of a Research Diagram, a Tangent Research Diagram may be displayed to the right of the main Research Diagram. In the context of a Research List this information is displayed below the main research. Tangent links allow a user to quickly refocus their browser to the tangent research. Graphical elements may be employed to “connect” the tangent research to it's point of inception in the research project. If a tangent line of research becomes overly complex it may be converted, by the user, into a Subsearch. Tangents may also be “hidden” from view to maintain the “focus” of the main research project.

A user may also generate “reports” of their research by selecting one or more Information Boxes. The user may choose to create a “printer friendly” version the selected information and or export the pages as usable file such as a PDF. Custom Reports may be generated by selecting one or more Information Boxes and then activating the custom report button. The user may be presented with additional options at this stage. For example including or excluding various types of information contained within the Information Box. Custom reports may then be exported as a useable file such as a PDF and/or displayed in a “printer friendly” format.

Dynamic Research Diagrams and Dynamic Lists also contain features specific to each. These include diagrams and inline viewing of content. The graphical, block diagram layout of the Dynamic Research Diagram provides a quick organized overview of a research project and allows the user to quickly view how a project has progressed over time. It also allows the user to see where decisions were made. Where as the Dynamic List view allows users to view captured content inline within the research project.

### BRIEF DESCRIPTION OF THE DRAWINGS

FIG. 1: Diagrams a typical architectural view of information collection, storage and display.

FIG. 2: Illustrates Dynamic Research Diagram view of research project.

FIG. 3: Illustrates Dynamic List view of research project.

FIG. 4: Illustrates in line display of stored content within a Dynamic List.

FIG. 5: Illustrates a Sub Search in a List View

FIG. 6: Illustrates a Sub Search in a dynamic Research Diagram view

FIG. 7: Illustrates a List Page which can be a List Page and/or a Conclusion Page

### PREFERRED IMPLEMENTATION

While an online application is the preferred method for deploying Dynamic Research Diagrams and Lists, it is to be understood that this invention is not limited to any particular software and/or hardware platform, nor is it a requirement that it be deployed as an online application as it can be deployed as device specific software as well. When we refer to a database, this may reference one and/or more databases as a particular implementation may require.

### DEFINITIONS

Block Diagram—is a pictorial model of a process and/or system.

Button: (in a graphical user interface) any of the small, labeled areas upon which the user can click with a mouse to trigger an event and/or choose an option.

Conclusion Page—a page, within a research project, that contains the pertinent information a researcher required to reach their conclusion.

Content—The material, including text, graphics, images, video and other media, that constitutes a web page, publication, file and/or document.

Drag and Drop—A method for manipulating files, content and text within a graphical user interface. The user moves the pointer over an icon, text and/or graphical element representing a section of content and activates the selection of the content. This may be accomplished by a mouse, stylus and/or other user input device. The user continues to activate the content while moving the content (dragging) to another place, and then deactivates the content (dropping). The meaning of this action can often be modified by holding certain keys on the keyboard at the same time.

Dynamic Research Diagram—an interactive block diagram, incorporating “layers” of information and links, organized within “containers” used for displaying and organizing the details of a research project. Also referred to as Research Diagram, Diagram View and/or Diagram Page.

Dynamic Research List—an interactive list, incorporating “layers” of information and links, used for displaying and organizing the details of a research project. Also referred to as List View.

Favicons—favicon (short for favorites icon), also known as a website icon, page icon or url icon, is an icon associated with a particular website or webpage.

Information Box—a container, which may be visible and graphical in nature or invisible, used to identify a subset of information collected within a research project. Usually with the information contained referencing a particular web page, document, graphic, media or idea. Text, color and graphical elements may be used to enhance the user experience. Information Box may also be used to describe the default Information Box used within a research project.

Link—An object, as text and/or graphics, connected through hypertext to a web page, document, another object, etc.

Keyword—A word used as a reference point for finding other words or information. Keywords may also be referred to as tags. (see tags)

List Page—is a page within a research project that includes a subset of information contained within the full research project. This series Information Boxes are displayed together in a meaningful grouping or sequence so as to constitute a record.

PDF—is an acronym standing for Personal Document Format.

Research Project—An investigation or collection of research findings. Also referred to as a project.

Upload—To transfer data from one's own computer or digital device to a server or host computer.

URL—an acronym for Uniform Resource Locator, which designates the “address” and/or location of a document and/or website and/or web page and/or other information on the Internet.

Search—To look for specific data in a file and/or an occurrence of text in a file. A search implies sequential scanning of content and/or indexes in order to find the results rather than a direct lookup. A search on the Internet yields a list of web pages that contain all the words in the search criteria.

Search Engine—Software that searches for data based on some criteria. Although a search engine is technically the software and algorithms used to perform a search, the term has become synonymous with the Web site itself. For example, Google is a major search site on the Web, but rather than being called the “Google search site,” it is commonly known as the “Google search engine.”

Tags—A label assigned to identify data in memory.

Tangent Research—a line of research digressing suddenly from one course of action or thought and turning to another.

Thumbnail—A reduced image of a graphic and/or document page, used in order to view multiple images on a screen simultaneously and/or to download such images more rapidly.

WYSIWYG—an acronym used for text editing which stands for What You See Is What You Get

Information Box—a container for a collection of information pertaining to a specific site and/or idea which may be graphical in nature. Also referred to as a “Box” and/or an iBox.

User—a human, agent and/or other mechanism capable of carrying out a search.

### DETAILED DESCRIPTION OF DRAWINGS

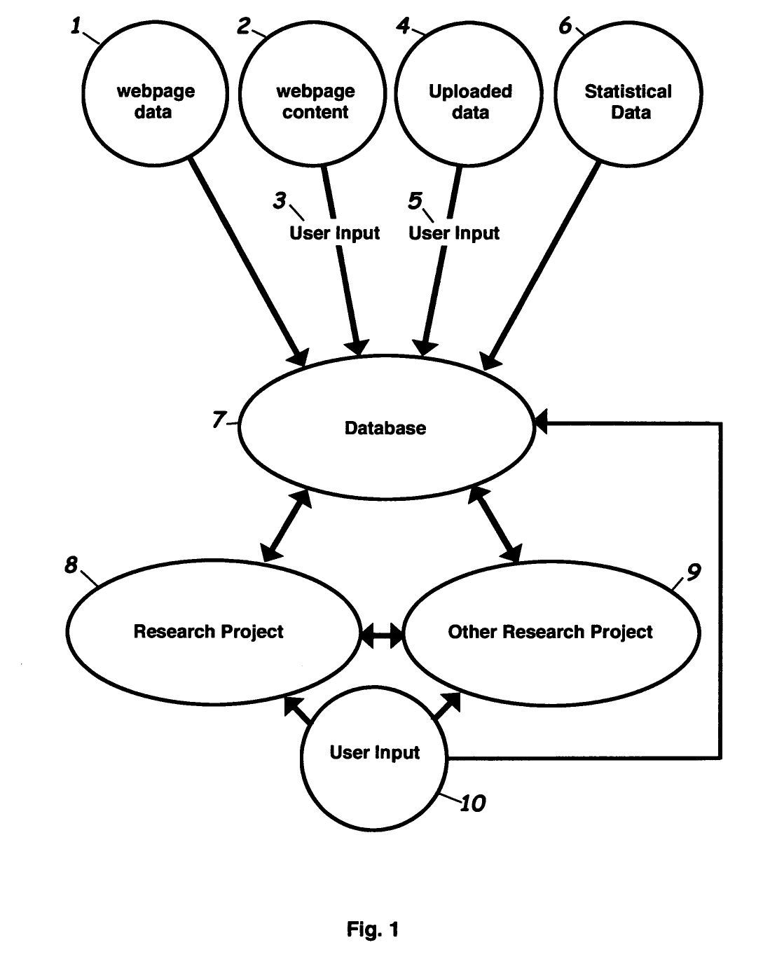

FIG. 1: Diagrams the architectural view of information collection, storage and display. Once a project is started/created 10 within the database the user may begin aggregating information. Information can be automatically collected from visited web pages 1. It can come from user selected content from a visited web page 2. This captured data can be further enhanced with user input, which may include notes, titles and quote, at the time it is captured 3. A user can upload their own images, documents, and/or other data 4 and user input may be added 5. In addition to the data collected from a web page, statistical data such as time and date stamps, duration of time spent on page, number of times a page has been visited and by whom and name of user who created the Information Box may also be added. All of this information is stored within a database for retrieval and display in the Research Project. The captured information can then be organized within a Research Project 8 and other Research Projects 9. The user(s) can further edit the stored information 10 within a Research Project 8 and other Research Projects 9. These edits and further organization are stored in the database.

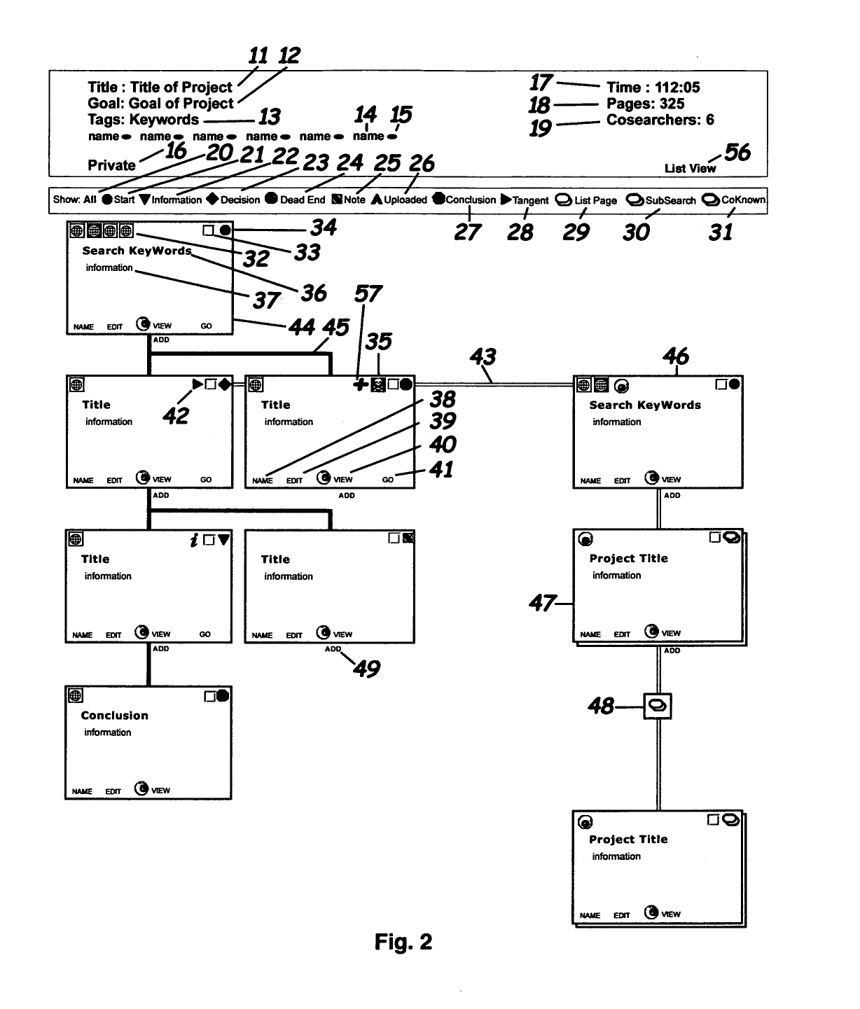

FIG. 2: Illustrates Dynamic Research Diagram view of research project. The overall structure of a Research Diagram is composed of project information 11, 12, 13, 14, 15, 17, 18, 19, privacy state 16, filtering systems (menus) 14, 15, 20-31 and Information Boxes contained in a block diagram 34-49. There is also a method for switching between Diagram and List views of the project 56 which may be either text and/or graphical in nature.

General project information may include a title, goal and keywords which may be edited by the user. The “project title” 11 may be a short description of the project. The “project goal” 12 may be used to describe the project in greater detail and/or describe goals of the project. Tags 13 may be described as keywords, tags and/or meta information and are individual words which can be used to describe the contents, goals, users and other information about the project.

The title, goal & tags may be used by an internal search engine to create searchable results for users to find and/or retrieve the project if the project is in a “Public” and/or “Private” state. The privacy state of the project may be indicated in the header 16. This state may be editable by the project's creator and/or user(s) who have been granted sufficient permission. There are also a number of other possible privacy states which can be implemented to accommodate higher levels of security and/or control of the dissemination of research projects. Other information and saved content may also be searchable, either separately and/or in conjunction with searching the title, goal and keywords.

Users involved in the project may be listed 14 and their contributions may be filtered 15. The user listings may be text and/or graphical in nature and the filtering may be accomplished by clicking on a link and/or graphic within a “menu” style layout. Additional information about users may also be displayed within the context of this “menu” such as where a user is logged in to the system and/or by activating the user's listing to reveal communication information and tools.

Statistical information presented in the header may include total time on project 17, number of web pages visited 18 and number of users involved in project 19. This is a sample representation of the types of statistical information that might be provided, other information may also be displayed within this context. For example user specific statistics, start and completion dates, ratings etc.

The Information Boxes menu 20-31 may be used as a filtering method. This allows a user to “hide” Information Boxes within a research project. In this way a user can further condense the amount of displayed information and allow them to “see” the relevant information more clearly. For example deactivating List Pages in the Information Boxes menu 29 collapses the List Page box 48 in the Research Diagram. For example a user reviewing a research project may desire to see only the “decision” Information Boxes within a research project, which could allow them to quickly review where decisions have been made within a research project.

The primary organization of Information Boxes within a Research Diagram is in the form of a block diagram and is composed of Information Boxes 44 and connections 43, 45. The primary ordering of these boxes is chronological, however a user may add new web pages, notes and/or uploaded content by click on the “add” button(s) 49. An “add” button may be may be text and/or graphical in nature. These “add” buttons may also link to an interface allowing for additional functionality. Examples include: uploading content to the site, inserting an Information Box unrelated to the search and creating a “note” page. Information Boxes that are added out of chronological sequence may be identified 57 by text and/or graphic elements. This identifier may be activated to provide information about when and why they have been added.

Information Boxes 44, 47 are the organizational containers and/or “blocks” within the block diagram structure. These containers may be visible and/or invisible and may use color and/or graphical elements 47 to enhance the user experience. Color and/or graphical elements may also be used to indicated “new” content that has been added to a research project. “Connections” (or connectors) may also use color and/or graphical elements 45, 43. These “connections” may be used to display the “flow” of the research projects development.

Information Boxes may contain a number of elements including: Favicons 32, icons 35, a method for selecting one and/or more boxes 33, site specific icons 34, 42, site generated and/or user generated text 36, 37, as well as buttons and links 38-41. Favicons 32 serve as mnemonic devices and may also serve the additional function providing information about the visited site they represent when activated. Site Specific icons, 34, 42 are representative of icons associated with types of information boxes, also shown in the information boxes menu 20-31. Icons 35 are mnemonic devices and can be user defined/created and/or provided by the site. They may also contain additional information (generated by the site and/or user defined) when activated. Site specific icons 34 may be used to represent the nature of the Information Box and/or have additional functionality when activated, such as the tangent icon 42. For example when a tangent icon is activated in can “focus” the browser window to the relevant portion of the research project. They may also provide additional information (generated by the site and/or user defined) when activated. The “title” 36 section of an Information Box may contain information generated the user, web page visited and/or by the site. Examples include: the key words used in a search, a “title” created by the user at the time the Information Box was created and/or automatically generated from the title of a visited page. The “information” 37 section of an Information Box may contain information generated the user, web page visited and/or by the site. When multiple users are working on the same project their “name” 38 may be displayed in the Information Box. This “name” may be text and/or graphical in nature and be a real user's name and/or a alias. This “name” may also provide additional information about the user and/or means of contacting the user directly and/or indirectly when activated. The “edit” button 39 may provide an interface for editing the content of an Information Box when activated. This can allow the user to edit the information, links and icons within an Information Box. It may also be used to add a “note” for themselves and/or other users to the Information Box. For example “Tom-Please review.” The “view” button 40 may be text and/or graphical in nature and may provide a link to content originating from a web page, user generated information and/or uploaded content. The “view” button may also provide a link capable of displaying the results of a previously performed search within one and/or more search engines. The “go” button 41 may be text and/or graphical in nature and may provide a link to a web page.

Tangents may be displayed to the right of the main research project and text and/or graphical elements 43 may be used to visually connect them to original inception point of the tangent. A user may “refocus” their browser to the tangent research from within the context of a research project by activating the tangent button 42 which may text and/or graphical in nature. Tangents may also be visually identifiable by the use of color and/or other graphical elements.

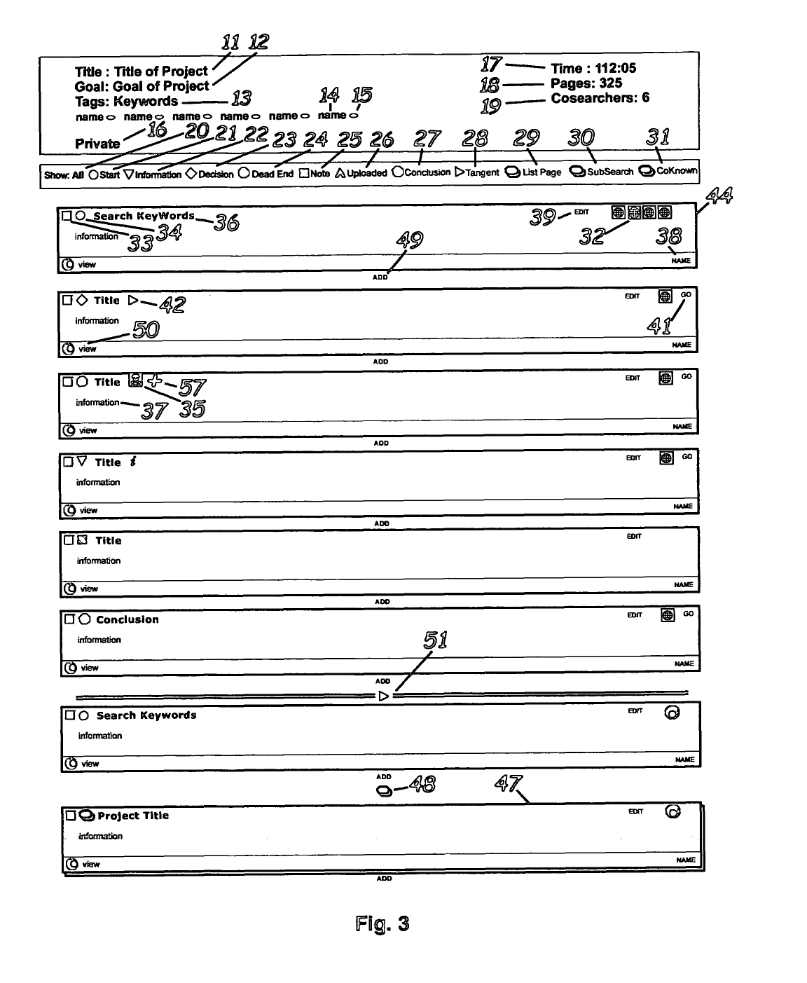

FIG. 3 illustrates a Dynamic Research List containing the same content (Information Boxes) as shown in FIG. 2. A Dynamic Research List includes much of the same functionality and components as a Dynamic Research Diagram with elements 11-49 maintaining the same functionality as described in the descriptions for FIG. 2. The primary organization of Information Boxes within a Research List is in a format where each subsequently added Information Box being positioned below the preceding Information Box. The primary ordering method may be chronological and/or reverse chronological order. Information Boxes 44 are the organizational containers within the “list” structure. These information blocks may be visible and/or invisible and may use color and/or graphical elements 44, 47 to enhance the user experience. Color and/or graphical elements may also be used to indicated “new” content that has been added to a research project.

A user may add new web pages, notes and/or uploaded content by activating the “add” button(s) 49. An “add” button may be may be text and/or graphical in nature. These “add” buttons may also link to an interface allowing for additional functionality. Examples include: uploading content to the site, inserting an Information Box unrelated to the search and creating a “note” page. Information Boxes that are “added” out of chronological sequence may be identified 57 by text and/or graphic elements. This identifier may be activated to provide information about when and why they have been “added”.

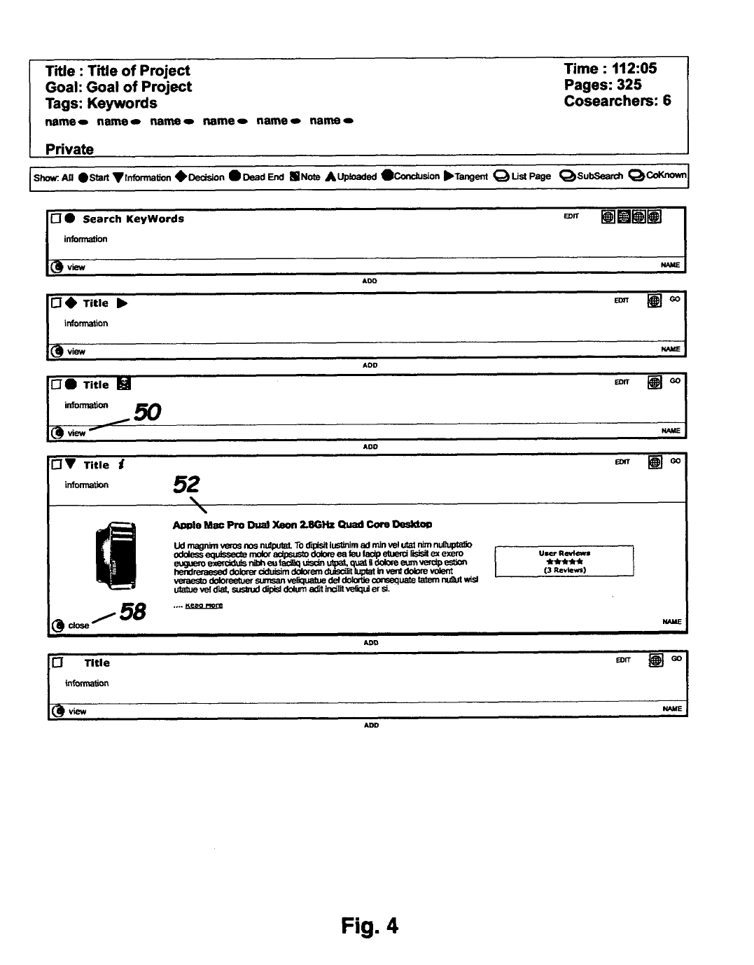

A user may view one and/or more content items inline within the context of a “list” by activating the “view” button(s) 50 (illustrated in FIG. 4). This allows a user to view multiple pieces of content (from a web page, uploaded and/or user created) simultaneously.

Tangents may be displayed below the main research project and text and/or graphical elements 51 may be used to visually separate a tangent from the main research and other tangents. This element 51 may be used to return the user to the original inception point of the tangent. A user may “refocus” their browser to the tangent from within the context of a research project by activating the tangent button 42 which may be text and/or graphical in nature. Tangents may also be visually identifiable by the use of color and/or other graphical elements.

FIG. 4 illustrates an “open” content container 52. A user may view content (from web pages, user generated information and/or uploaded content) inline within the context of a “list”. One and/or more containers may be “opened” by activating the “view” button 50 and closed/hidden by activating the “close” button 58.

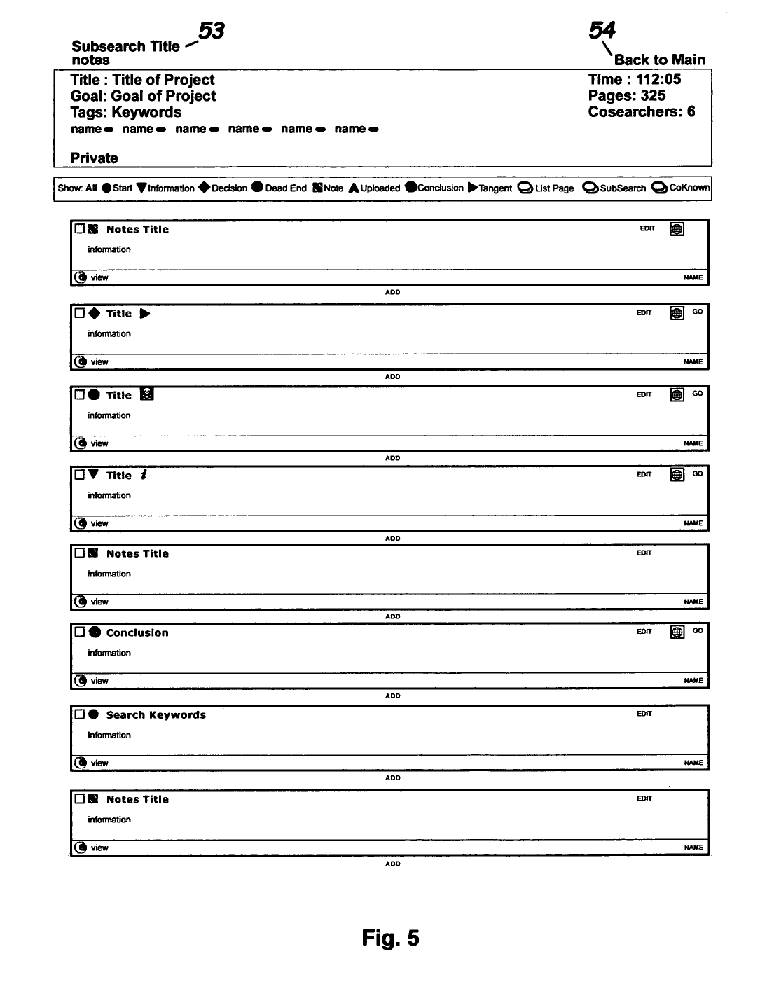

FIG. 5: A Subsearch, Research List contains the same features as a the parent Dynamic Research List with the additions an editable title and information about the Subsearch 53. It also has a method for returning back to the parent Dynamic Research List 54. A user may switch between List and Diagram views within the context of a Subsearch FIG. 2-56. This switch may be accomplished by a button and/or other similar method that may be text and/or graphical in nature.

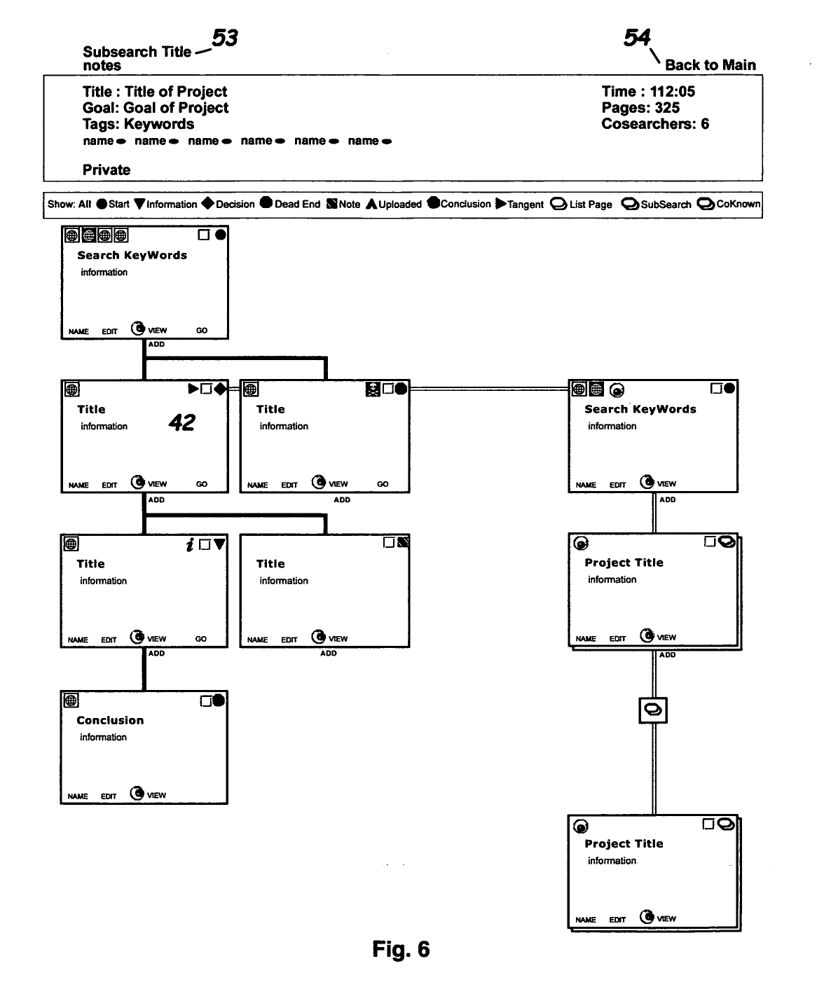

FIG. 6: A Subsearch Research Diagram contains all the same features as a the parent Dynamic Research Diagram with the additions an editable title and information about the Subsearch 53. It also has a method for returning back to the parent Dynamic Research Diagram 54. A user may switch between List and Diagram views within the context of a Subsearch FIG. 2-56. This switch may be accomplished by a button and/or other similar method that may be text and/or graphical in nature.

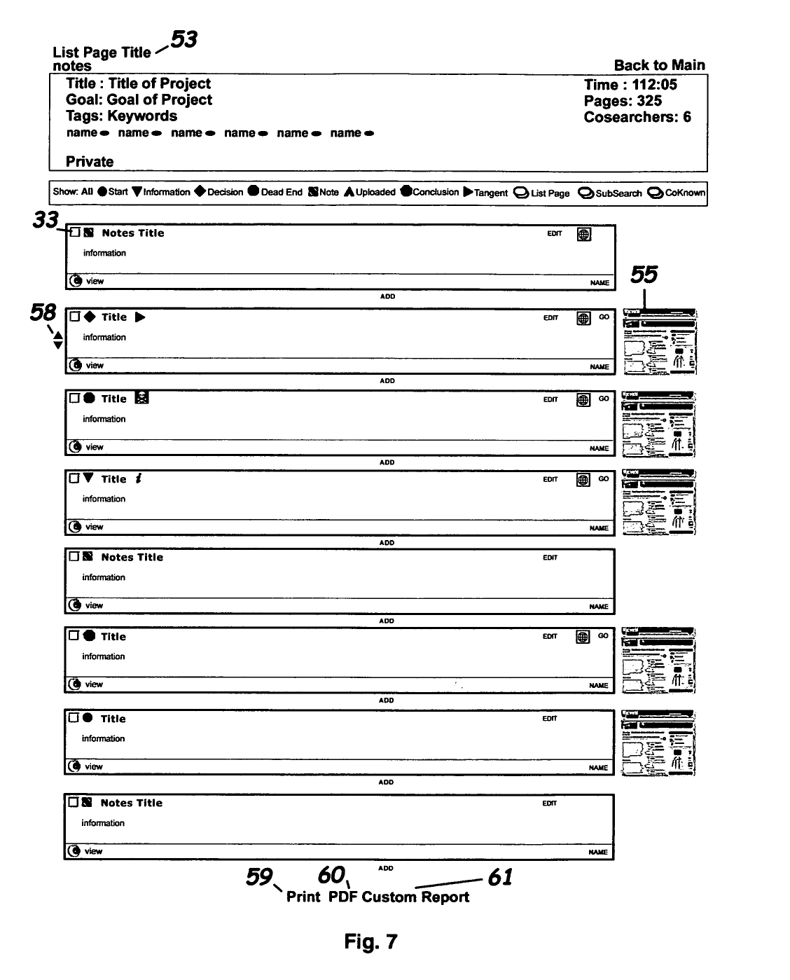

FIG. 7: Illustrates a List page or a Conclusion page. These pages may include thumbnails of web pages 55 which provide a mnemonic device for the user. A thumbnail may also act as link to the represented web page. Thumbnails may also be activated to display a larger image of the represented web page and/or provide additional information. List and Conclusion Pages may be ordered by the user. This may be accomplished by means of buttons 58, which may be text and/or graphical in nature, and/or by a drag and drop or similar method.

A user may also generate “reports” of their research by activating different buttons 59, 60, 61. These buttons may be text and/or graphical in nature and may be available on any of the pages constituting a research project. The “print” button may be used to create a “printer friendly” version of the page 59. The PDF button may be used to export the contents of a page as a PDF 60. The “custom report” button 61 may be used to begin the process of generating a custom report. Custom reports may be generated by selecting 33 one and/or more Information Boxes and then activating the custom report button. The user may be presented with additional options at this stage. For example including and/or excluding various types of information contained within the Information Box. Custom reports may then be exported as PDFs and/or displayed in a “printer friendly” format.

1) A method of organizing Internet/Intranet research with interactive Dynamic Research Diagrams and Lists.
